(19) United States
(12) Patent Application Publication
(10) Pub. No.: US 2018/0186019 A1
(43) Pub. Date: Jul. 5, 2018

(54) ELECTRICALLY ACTIVATED CUTTING UTENSIL

(71) Applicant: Stephanie Fieil, Munds Park, AZ (US)

(72) Inventor: Stephanie Fieil, Munds Park, AZ (US)

(21) Appl. No.: 15/398,932

(22) Filed: Jan. 5, 2017

(51) Int. Cl. B26B 11/00; B26B 7/00; B26B 9/02; B26B 5/00; B23D 49/11; B23D 51/16; B25G 1/10

(52) U.S. Cl. CPC B26B 11/008; B26B 7/00; B26B 9/02; B25G 1/102; B23D 49/11; B23D 51/16; B26B 5/00

(57) ABSTRACT

An electric steak knife comprising a serrated blade with an attachment means at a first end and a serrated section at a second end, a handle portion adapted for gripping, wherein the handle portion has an opening sized to receive the serrated blade and the handle portion is substantially hollow, a motor enclosed within the handle portion and attached to the attachment means at the first end of the serrated blade, a mechanism for converting the rotatory motion of the motor into vibratory motion of the serrated blade, and a switch to start and stop the motor.

### BACKGROUND OF THE INVENTION

The present invention relates to knife, and more particularly to a knife that is electrically activated to assist a person with cutting.

Many people have problem cutting their food or other items with a knife for various reasons. Some have medical issues such as arthritis, broken hands, torn ligaments or tendons. Some are of an older age and have lost the strength or dexterity to cut their food. A knife that would assist these and many other persons to be more self-sufficient and able to cut their food on their own would be beneficial both for independence, but also for the person's moral and self-confidence.

The electric knife consists of a movable blade connected to a motor to assist in cutting through tougher item such as steaks. However, many electric knives are to large or bulky for a person with arthritis or strength issues to use effectively. Therefore, there is room for improvement in this area of cutlery.

Thus, a need is appreciated for an electric steak knife which is convenient to handle by old or arthritic patients and allow them to assist themselves.

### SUMMARY

Aspects of an embodiment of the present invention disclose an electric steak knife comprising a serrated blade with an attachment means at a first end and a serrated section at a second end, a handle portion adapted for gripping, wherein the handle portion has an opening sized to receive the serrated blade and the handle portion is substantially hollow, a motor enclosed within the handle portion and attached to the attachment means at the first end of the serrated blade, a mechanism for converting the rotatory motion of the motor into vibratory motion of the serrated blade, and a switch to start and stop the motor.

### BRIEF DESCRIPTION OF THE DRAWINGS

FIG. 1 depicts an isometric view of one side of a knife, in accordance with one embodiment of the present invention.

FIG. 2 depicts an isometric view of a rear side of the knife, in accordance with one embodiment of the present invention.

FIG. 3 depicts a block diagram showing the internal components of the knife, in accordance with one embodiment of the present invention.

### DETAILED DESCRIPTION OF THE INVENTION

The present invention provides an electronic knife that is ergonomically designed, and small enough in size to be usable by people with arthritis or lose of dexterity in their hands a knife. The knife is easily turned on and the movement of the blade may be adjusted to a speed that is comfortable for the person to operate the knife safely and independently.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein may also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

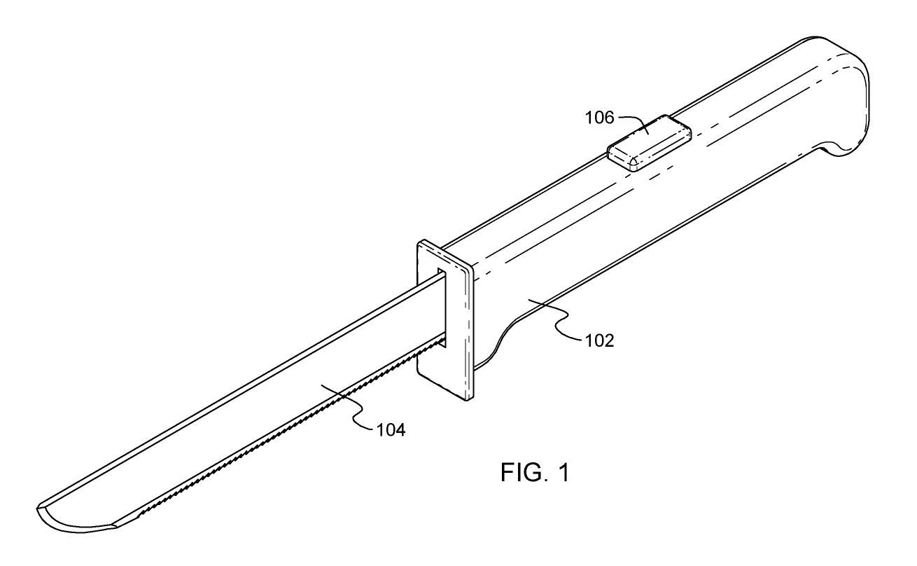

FIG. 1 depicts an isometric view of the knife 100, in accordance with one embodiment of the present invention. As shown in FIG. 1, the knife 100 has a handle portion 102, a blade 104 attached to the handle, and a power switch 106 integrated into the handle portion 102.

The handle portion 102 is designed to ergonomically fit in the hands of the person and provide an enclosure for the necessary components. In the depicted embodiment, the handle portion 102 is substantially the same size as the average steak knife. The smaller size of the handle portion 102 provides the easiest use for the person, compared to the current design of electric knives that are large and bulky. In additional embodiments, the handle portion 102 may be various sizes depending on the size of the blade 104. The handle portion 102 may be made from various materials that are both light weight and durable, such materials may be thermoplastics, metals, woods, or a combination of these and other materials know in the art.

In the depicted embodiment, the handle portion 102 has a power switch 106 located distal to the second end of the handle portion 102. In additional embodiments, the power switch 106 may be positioned else on the handle portion 102 to provide for the most ergonomic design of the knife 100. In additional embodiments, the power switch 106 may be integrated into predetermined positions on the handle portion 102 and additional switches and release buttons may also be integrated into the surface of the handle portion 102 for additional features. In some embodiments, a charging port for a battery may be integrated into the handle portion 102 or a plug and cord may be integrated into the handle portion 102.

Some additional features as will be explained in detail below are, but not limited to, a heating element to heat the blade to further increase the ease of cutting, and a blade release to allow for the blade to become detached for cleaning purposes and to incorporate other style blades.

The handle portion 102 may be comprised of several different pieces that are assembled with the use of welding, heat, adhesives, locks, or other means known to those in the art. In additional embodiments, the handle portion 102 is a unitarily constructed piece. The handle portion 102 has an opening located at a first end where the blade 104 extends through. In some embodiments, the opening has a water tight seal around the blade 104 to substantially decrease the opportunity for a liquid to enter the handle portion 102.

The blade 104 is a thin blade fashioned out of a suitable material, such as metal or plastic, that is stiff yet flexible. The blade 104 has two ends, a cutting end and an attachment end. In the depicted embodiment, the cutting end of the blade 104 is serrated on a portion of one side of the blade 104 and dull on the opposite side of the blade 104. In additional embodiments, the blade 104 may be serrated on one or both sides, may non-serrated on one or both sides of the blade 104, or a mixture of the two. In one embodiment, the blade 104 has a plurality of teeth. The number of the teeth, the height of the teeth, the direction of the teeth may be modified.

To effectively cut the blade 104 must be flexible, yet sturdy enough to not break and also to provide additional weight to press down and through the item the person is attempting to cut through. The blade 104 must be stiff enough to effectively pierce the exterior of the item. This strong, thin blade 104 allows a great deal of force to be applied to the knife 100 in order to cut while also providing the precision necessary to cut. In the depicted embodiment, the blade 104 has a serrated cutting edge.

In some embodiments, the blade 104 is capable of conducting heat, to provide additional assistance in cutting cold objects. A portion of the blade 104 is made out of a material that is capable of allowing a current to flow from a heating source through the blade 104 to heat this predetermined section of the blade 104. A heating element may be used to heat the blade 104. A positive conductive end and a negative conductive end are disposed on front end and rear end of the blade 104 respectively and are used to connect with positive electrode and negative electrode of the heating element 306. In additional embodiments, a predetermined portion of the blade is made out a material that is able to conduct heat, while the remainder of the blade 104 is made from a different material that is able to withstand the heat. In some embodiments, the blade 104 can be heated to a range of 130^{˜}175 Fahrenheit degrees. In additional embodiments, the heating element may be controlled by a toggle switch to allow for the person to manually adjust the temperature of the blade 104 to provide adequate heat to cut through the object but not provide excess heat that would affect or damage the object.

The attachment end of the blade 104 is for connecting the blade 104 with the handle portion 102 via a locking mechanism (not shown). Various locking mechanisms may be used providing the locking mechanism keep the blade 104 sufficiently attached to the handle portion 102 during operation. Examples of types of locking mechanisms are pressure locks, pin locks, button locks, or other locks know to those in the art.

The power switch 106 controls the oscillation of the blade 104. In some embodiments, the power switch 106 is an on/off switch, that when activated toggles the motor which oscillates the blade 104. In additional embodiments, the power switch 106 is adjustable to allow for various oscillation speed. In one embodiment, the power switch 106 has a safety feature, wherein the person must continually press the power switch 106 to keep the blade 104 oscillating.

In additional embodiments, additional switches or buttons may be used. Such as a switch to control power to the heating element to heat the blade, a push button to release the blade 104 for cleaning, an electrical port to attached a power cord to operate the knife 100 or a power cord to charge an internal battery.

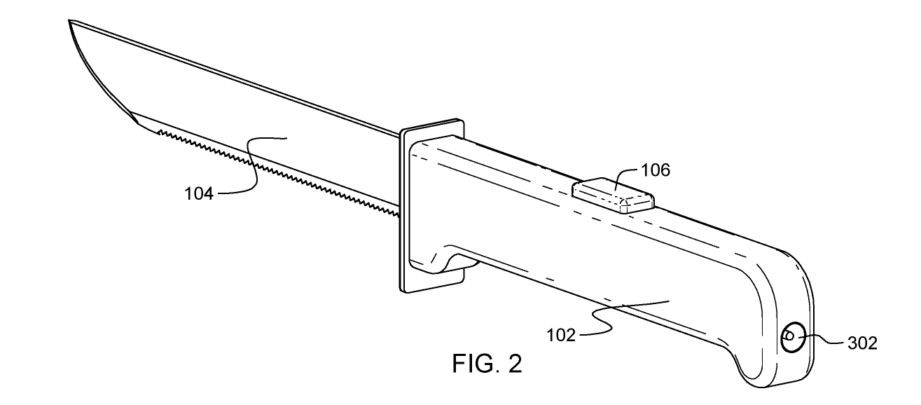

FIG. 2 depicts an isometric view of the knife 100, in accordance with one embodiment of the present invention. This Figure shows the design of the knife 100 in accordance with an average steak knife in both shape and size, and shows one embodiment of the position of the charging port 302.

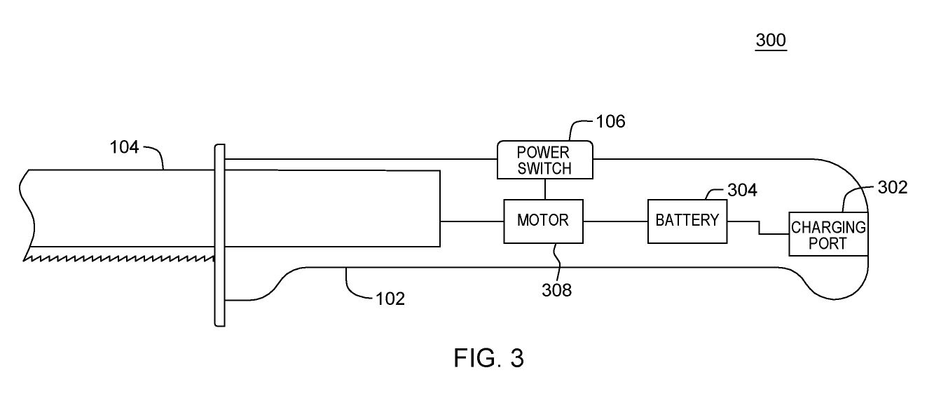

FIG. 3 depicts a block diagram of knife 100 showing the internal components of the handle portion 102, in accordance with one embodiment of the present invention. In the depicted embodiment, the handle portion 102 contains the power switch 106, a charging port 302, a battery 304, a motor 308. The shown embodiment is a block diagram to show the elements being enclosed or attached to the handle portion 102. The listed items are sized to fit within the handle portion 102, but various other positions, and structures are possible.

The charging port 302 connects a power source to the knife 100 to either charge the battery 304 or to provide additional power to the knife 100 in the event the battery is either dead or not present.

The battery 304 provides power to the motor 308. The battery is sized to provide adequate power, and longevity to last a set amount of time. In one embodiment, the battery is a rechargeable lithium battery. In additional embodiments, the battery is other rechargeable batteries known in the art. One embodiment, the battery 304 is a 3V 220 mAh battery. The battery 304 may provide AC or DC power at various voltage ratings.

The motor 308 provides the movement for the blade 104. The motor provides an oscillation motion to move the blade 104 back and forth. In additional embodiments, the motor may provide linear, or irregular motion. In the depicted embodiment, the motor 308 is connected to the power switch 106 and the battery 304. Various motors of differing speeds, strength, range of motion, and the like may be used depending on the size of the knife. In one embodiment, the motor 308 drives a shaft that turns at a minimum of 200 revolutions per minute to create a linear motion (back and forth) to move the blade 104 in an oscillating motion. The blade 104 is attached to the motor 308 by various means. The motor 308 may require an attachment means to connect the motor 308 and the blade 104. In additional embodiments, the motor 308 is connected directly to the blade 104. For instance if the motor is designed like a piston and can produce oscillating motions without additional components.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. An electric steak knife comprising:
a blade adapted for cutting steaks;
a handle portion adapted for gripping the electric steak knife in one hand of a person;
a motor enclosed within the handle portion for driving the blade;
a battery pack enclosed within handle portion for powering the DC motor;
a mechanism for converting the rotatory motion of the DC motor into vibratory motion of the blade;
a switch to start and stop said electric steak knife.

2. The electric steak knife of claim 1, wherein said blade is a stainless-steel blade.

3. The electric steak knife of claim 1, wherein said blade is a serrated stainless-steel blade.

4. The electric steak knife of claim 1, wherein said handle portion is adapted to be conveniently gripped by an arthritic patient in one hand.

5. The electric steak knife of claim 1, wherein said handle potion is adapted to be conveniently gripped by person with compromised hand muscle power in one hand.

6. The electric steak knife of claim 1, wherein said battery pack is a set of rechargeable batteries.

7. The electric steak knife of claim 1, wherein electric steak knife further comprises a port for coupling an adaptor for charging the battery pack.

8. An electric steak knife comprising:
a serrated blade with an attachment means at a first end and a serrated section at a second end;
a handle portion adapted for gripping, wherein the handle portion has an opening sized to receive the serrated blade and the handle portion is substantially hollow;
a motor enclosed within the handle portion and attached to the attachment means at the first end of the serrated blade;
a mechanism for converting the rotatory motion of the motor into vibratory motion of the serrated blade; and
a switch to start and stop the motor.

9. The electric steak knife of claim 8, further comprising a battery enclosed within the handle and electrically connected to the motor.

10. The electric steak knife of claim 8, wherein the serrated blade is stainless steel.

11. The electric steak knife of claim 9, further comprising a port attached to the handle portion and electrically attached to the batter.

12. The electric steak knife of claim 8, further comprising a port exposed on the surface of the handle portion and electrically connected to the power switch.

13. The electric steak knife of claim 8, wherein the handle potion is designed to be ergonomically shaped.

14. The electric steak knife of claim 9, wherein the battery is rechargeable.

15. The electric steak knife of claim 8, wherein the motor has variable speeds.

16. The electric steak knife of claim 8, wherein the serrated blade is made of a plurality of individual elements.

17. The electric steak knife of claim 16, further comprising a heating element electrically connected to the serrated blade and the battery.

18. The electric steak knife of claim 17, wherein a portion of the plurality of individual elements of the serrated blade may be heated to a predetermined temperature.

19. The electric steak knife of claim 8, wherein the handle portion is of a unitary construction.
